(19) United States
(12) Patent Application Publication
(10) Pub. No.: US 2020/0184528 A1
(43) Pub. Date: Jun. 11, 2020

(54) GIFTING SYSTEM AND METHOD OF USE

(71) Applicant: Courtney Young, Coppell, TX (US)

(72) Inventor: Courtney Young, Coppell, TX (US)

(21) Appl. No.: 16/706,256

(22) Filed: Dec. 6, 2019

Related U.S. Application Data
(60) Provisional application No. 62/776,085, filed on Dec. 6, 2018.

(51) Int. Cl. G06Q 30/06

(52) U.S. Cl. CPC G06Q 30/0615

(57) ABSTRACT

A method of gifting includes providing a portal to communicate between a first computing device associated with a first; receiving a selection of a gift and a first recipient from the first user through the first computing device and the portal; sending the gift anonymously to the first recipient; and receiving a second selection of a second gift and a second recipient from the recipient through a second computing device and the portal.

### BACKGROUND

### 1. Field of the Invention

The present invention relates generally to commerce systems, and more specifically, to a gifting system for anonymously arranging for a gift to be sent and then sent to another.

### 2. Description of Related Art

Commerce systems are well known in the art and are effective means to enable the transfer of goods or services from one party to another. For example, FIG. 1 depicts a conventional retail system 101 having a purchaser 103 who visits a retailer 105 to purchase a gift 107 for a recipient 109. The gift 107 is purchased, prepared and given to the recipient 109.

One of the problems commonly associated with system 101 is its limited efficiency. For example, while the gift 107 may be given anonymously, extra effort is required to make this happen. In addition, while the recipient 109 is thankful for the gift 107 they are left without efficient means to send a gift to another or thank the purchaser 109.

While the art contains methods and means of transferring a product or service no efficient means exists to perpetuate the concept of pay-it-forward, where a kind act sparks a perpetual round of sharing or gift giving.

Accordingly, although great strides have been made in the area of retail systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common retail system;

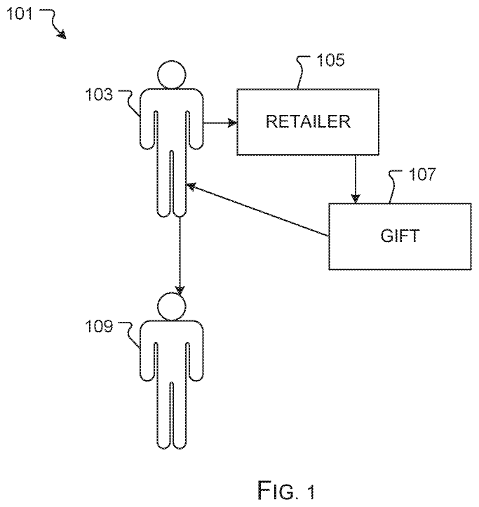

FIG. 2 is a diagram of a gifting system in accordance with a preferred embodiment of the present application; and

FIG. 3 is a flowchart of the preferred method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional retail systems. Specifically, the invention of the present application enables a person to anonymously receive a gift and efficiently send a gift to another person. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

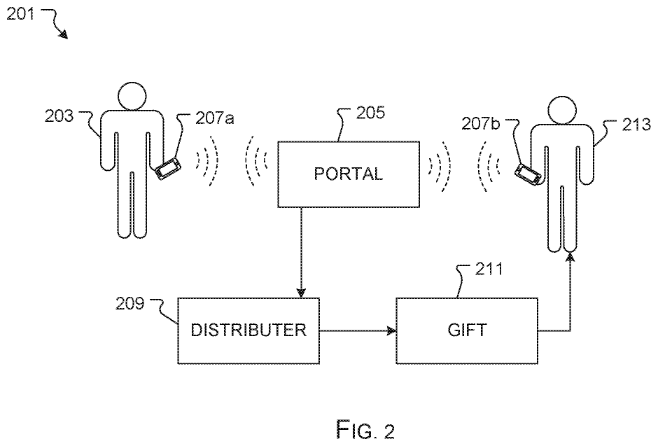

Referring now to the drawings wherein like reference characters identify corresponding or similar elements throughout the several views, FIG. 2 depicts a diagram of a gifting system in accordance with a preferred embodiment of the present application. It will be appreciated that system 201 overcomes one or more of the above-listed problems commonly associated with conventional retail systems.

In the contemplated embodiment, system 201 includes a first person 203 in communication with a portal 205 via a computing device 207a. The portal is in communication with a distributor 209 of gifts 211. The system 201 further includes a second person 213 with a computing device 207b.

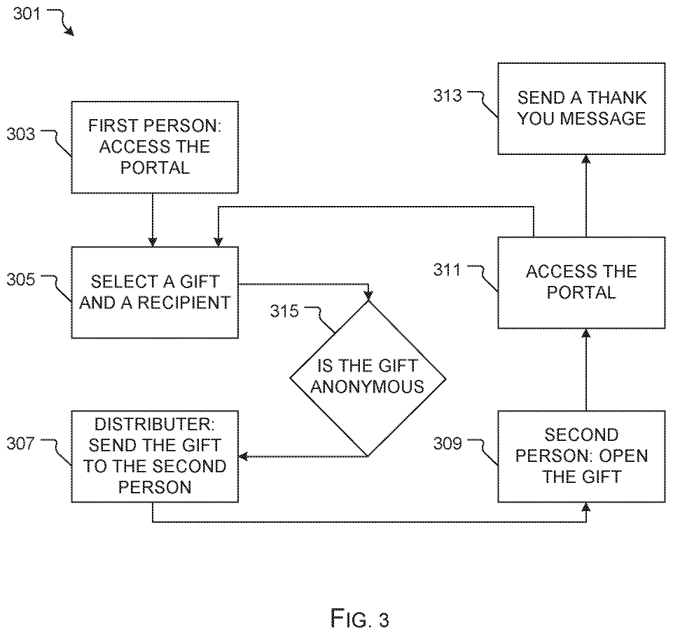

Referring now to FIG. 3 the preferred method of use of the system 201 is depicted. Method 301 includes the first person accessing the portal 303, selecting a gift and a recipient 305, the distributor sending the gift to the second person 307, the second person opening the gift 309, the second person accessing the portal 311 to send a thank you message 313 or sending a gift to a new second person 305. It is contemplated that the gifts will be sent anonymously 315 however they could also be sent with the information of the first person 203.

It will be understood that the designation of first person 203 and second person 213 are relative and that when the second person 213 returns to the portal 205 to send a gift 305 that they become the first person 203

It should be appreciated that one of the unique features believed characteristic of the present application is the preferred method of use of the system 301 enabling the repetitive and anonymous gifting 211 between many persons.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of gifting, the method comprising:
providing a portal configured to communicate between a first computing device associated with a first;
receiving a selection of a gift and a first recipient from the first user through the first computing device and the portal;
sending the gift anonymously to the first recipient; and
receiving a second selection of a second gift and a second recipient from the recipient through a second computing device and the portal.
